(19) United States
(12) Patent Application Publication
(10) Pub. No.: US 2015/0189427 A1
(43) Pub. Date: Jul. 2, 2015

(54) DEVICE AND METHOD FOR GENERATING DRIVING SIGNAL OF LOUDSPEAKER

(71) Applicant: RICHTEK TECHNOLOGY CORP, Hsinchu (TW)

(72) Inventor: Kuo Shih Tsai, Hsinchu (TW)

(21) Appl. No.: 14/304,732

(22) Filed: Jun. 13, 2014

(30) Foreign Application Priority Data
Dec. 31, 2013 (TW) 102149260

(51) Int. Cl. H04R 3/00

(52) U.S. Cl. CPC H04R 3/00; H04R 2430/00

(57) ABSTRACT

A method and device for generating a driving signal of a loudspeaker is provided. The method includes the steps of: outputting a driving voltage to a loudspeaker; measuring a current flowing through the loudspeaker; calculating to derive a voltage value corresponding to the current flowing through an electrical impedance of the loudspeaker, and calculating to derive a back-emf value by performing subtraction according to the driving voltage or a corresponding value thereof and the voltage value; integrating the back-emf value to derive an integrating value positive-correlating to a displacement of the diaphragm of the loudspeaker; and manipulating the driving voltage according to the integrating value to perform protection on the loudspeaker.

### CROSS REFERENCE TO RELATED APPLICATIONS

This non-provisional application claims priority claim under 35 U.S.C. §119(a) on Patent Application No. 102149260 filed in Taiwan, R.O.C. on Dec. 31, 2013, the entire contents of which are hereby incorporated by reference herein.

### BACKGROUND OF THE INVENTION

1. Field of the Invention

The present invention relates to a device and method for generating a driving signal of a loudspeaker and, more particularly, to a device and method for generating a driving signal of a loudspeaker, estimating the displacement of the diaphragm of a loudspeaker (that is, the diaphragm excursion) and preventing the loudspeaker from physical breakdown.

2. Description of Related Art

To protect the physical structure of a loudspeaker from being permanently damaged, it is a practice not to directly drive a loudspeaker with a linearly-amplified audio signal, which may, if the driving signal is too large, cause greater diaphragm excursion or even exceed beyond the displacement limit, thus leading to a change in the property, a shorter lifetime, or damage to the structure, of the diaphragm of the loudspeaker. On the other hand, to have better listening experience, one may put the output volume of the loudspeaker to its limit, which may stress the diaphragm excursion of the loudspeaker to the displacement limit. Therefore, it has become an issue of the design of a loudspeaker and its driving circuit on how to detect, or predict, the diaphragm excursion of the loudspeaker so as to make an optimal tradeoff between the output volume and the protection of the loudspeaker.

FIG. 1 shows an equivalent circuit diagram of a prior-art loudspeaker 100 having two terminal inputs 110. By applying a driving voltage u at the two terminal inputs 110, the diaphragm of the loudspeaker 100 is induced to vibrate so as to generate human-perceivable sound waves. In the equivalent circuit of the loudspeaker 100, the circuit of the electrical impedance and the back electromotive force (back-emf) parallels the aspect of the electrical property of the loudspeaker 100, while the circuit of the electromagnetic force (EM-force) and mechanical impedance parallels the aspect of the mechanical property of the loudspeaker 100.

The driving voltage u at the terminal inputs 110 forms a current i. In the aspect of the mechanical property of the loudspeaker 100, an EM-force with a magnitude of Φ*i is formed due to the induction caused by the current i, where Φ is the force factor, which is a characteristic parameter of the loudspeaker, and the EM-force causes a velocity of displacement v on the diaphragm of the loudspeaker with a mechanical impedance Zm. The correlation is shown as followed:

Φ·i=Zm·v (1)

The function of the velocity of displacement v can be derived from equation (1). As shown in FIG. 1, the equivalent circuit has a back-emf with magnitude of Φ*v and indicates that the driving voltage u is not fully applied on the electrical impedance Ze; instead, the mechanical aspect of the loudspeaker generates a voltage of the back-emf with magnitude of Φ*v, where the voltage is connected to the electrical impedance Ze in series. That is to say, the cross voltage on the electrical impedance Ze equals the driving voltage u minus the back-emf Φ*v.

Please refer to the prior art of European patent EP2355542B1. In the prior art, a transfer function Hvx of “the input voltage versus the displacement” in frequency domain is derived based on the equivalent circuit shown in FIG. 1. Hvx is shown as followed:

$${H}_{vx} ( jw ) = \frac{\frac{Φ}{jw}}{{Z}_{m} ( jw ) \cdot Z ( jw )} , \qquad ( 2 )$$

wherein Zm is the mechanical impedance in frequency domain by Laplace transformation, Z is “the input voltage divided by the current” in frequency domain by Laplace transformation, jw is the frequency variable in frequency domain, and Φ is the force factor. The above-mentioned displacement means the diaphragm excursion of the loudspeaker. In more detail, Zm can be further interpreted as followed:

$${Z}_{m} ( jw ) = \frac{{Φ}^{2}}{Z ( jw ) \cdot {Z}_{e} ( jw )} , \qquad ( 3 )$$

wherein Ze is the electrical impedance in frequency domain by Laplace transformation.

If the input signal in frequency domain by Laplace transformation is multiplied by equation (3), the displacement in frequency domain by Laplace transformation can be derived. After performing the inverse Laplace transformation, the displacement in time domain can be further derived. However, there are at least two drawbacks on this prior art.

First, the algorithmic operation of the Laplace transformation and the inverse Laplace transformation requires many calculation resources, resulting in larger circuit area and more power consumption.

Second, the force factor Φ is regarded as a constant in the calculation of the frequency domain. However, as shown in FIG. 2, the continuous line shows the correlation of the force factor Φ versus the displacement in a loudspeaker of an overhang topology, and the dashed line shows that in a loudspeaker of an equal-length topology. Therefore, it can be understood that the force factor Φ changes with different displacements and loudspeaker categories, which is not considered in the prior art, thus, the accuracy of the estimation is affected.

### SUMMARY

In view of the foregoing, a device and method for generating a driving signal of a loudspeaker is provided. More particularly, a device and method for generating a driving signal of a loudspeaker estimating the displacement of the diaphragm of a loudspeaker and preventing the loudspeaker from physical breakdown is provided.

The present invention provides a method for generating a driving signal of a loudspeaker. The method includes the steps of: outputting a driving voltage to a loudspeaker; measuring a current flowing through the loudspeaker; calculating to derive a voltage value corresponding to the current flowing through an electrical impedance of the loudspeaker, and calculating to derive a back-emf value by performing subtraction according to the driving voltage or a corresponding value thereof and the voltage value; integrating the back-emf value to derive an integrating value positive-correlating to a displacement of the diaphragm of the loudspeaker; and manipulating the driving voltage according to the integrating value to perform protection on the loudspeaker.

In one embodiment of the present invention, the step of calculating to derive the back-emf value further comprises deriving a product by multiplying the current by the electrical impedance, and deriving the back-emf value by subtracting the product from the driving voltage.

In one embodiment of the present invention, the method further comprises the step of deriving the displacement by dividing the integrating value by a force factor of the loudspeaker, and manipulating the driving voltage according to the displacement to perform protection on the loudspeaker.

In one embodiment of the present invention, the force factor is a function of the displacement.

In one embodiment of the present invention, the protection on the loudspeaker is performed by manipulating the amplitude of the driving voltage linearly or non-linearly such that the displacement of the diaphragm of the loudspeaker is not greater than a limiting value.

The present invention also provides a device for generating a driving signal of a loudspeaker. The device includes: a driving circuit, coupled to the loudspeaker, and receiving a control signal to generate the driving voltage; a current sensing unit, coupled to the loudspeaker, and measuring a current flowing through the loudspeaker to generate a current signal; a displacement calculating unit, coupled to the current sensing unit, calculating to derive a back-emf value according to the driving voltage, the current signal and the electrical impedance of the loudspeaker, and integrating the back-emf value to derive an integrating value; and a signal processing unit, coupled to the displacement calculating unit and the driving circuit, receiving an audio signal to generate the control signal, and manipulating the control signal according to the integrating value to perform protection on the loudspeaker.

In one embodiment of the present invention, the displacement calculating unit calculates to derive a voltage value corresponding to the current flowing through the electrical impedance of the loudspeaker, and derives the back-emf value by performing subtraction according to the driving voltage or a corresponding value thereof and the voltage value.

In one embodiment of the present invention, the displacement calculating unit derives a product by multiplying the current signal by the electrical impedance, and derives the back-emf value by subtracting the product from the driving voltage.

In one embodiment of the present invention, the signal processing unit comprises a digital signal processor (DSP) and a digital-to-analog converter (DAC), the DSP coupled to the displacement calculating unit and receiving the audio signal, the DAC coupled to the DSP and the driving circuit and generating the control signal.

In one embodiment of the present invention, the current sensing unit comprises a sensing circuit and an analog-to-digital converter (ADC), the sensing circuit coupled to the loudspeaker to measure the current flowing through the loudspeaker, the ADC coupled to the sensing circuit and the displacement calculating unit and outputting the current signal.

In one embodiment of the present invention, the displacement calculating unit further deriving a displacement of the diaphragm of the loudspeaker by dividing the integrating value by a force factor of the loudspeaker, and the signal processing unit manipulating the control signal according to the displacement to perform protection on the loudspeaker.

In one embodiment of the present invention, the force factor is a function of the displacement.

In one embodiment of the present invention, protection on the loudspeaker is performed by the signal processing unit manipulating the amplitude of the driving voltage linearly or non-linearly such that the displacement of the diaphragm of the loudspeaker is not greater than a limiting value.

The advantageous effect of the present invention over conventional approaches is that the present device and method is able to predict the displacement of the diaphragm of the loudspeaker in time and accurately by taking the correlation of the force factor versus the displacement into consideration. Therefore, protection on the loudspeaker can be performed, and the optimized maximal output sound volume can be reached while the physical damage on the diaphragm of the loudspeaker can be avoided.

### BRIEF DESCRIPTION OF THE DRAWINGS

The structure as well as a preferred mode of use, further objects, and advantages of the present invention will be best understood by referring to the following detailed description of some illustrative embodiments in conjunction with the accompanying drawings, in which:

FIG. 1 is an equivalent circuit diagram of a prior-art loudspeaker;

FIG. 2 is a function graph of a displacement versus a force factor of a prior-art loudspeaker;

FIG. 3 is a circuit block diagram showing a device for generating a driving signal of a loudspeaker of the first embodiment of the present invention;

FIG. 4 is a graph showing the relation of an integrating value and the corresponding displacement;

FIG. 5 is a flowchart of a method for generating a driving signal of a loudspeaker according to the second embodiment of the present invention; and

FIG. 6 is a flowchart of a method for generating a driving signal of a loudspeaker according to the third embodiment of the present invention.

### DETAILED DESCRIPTION OF THE EMBODIMENTS

In the description hereinafter, the term of “coupled” or “coupling” refers to any two objects directly or indirectly electrically connected to each other. Therefore, if it is described that “a first device is coupled to a second device,” the meaning is that the first device is either directly electrically connected to the second device or indirectly electrically connected to the second device through other devices or connection means.

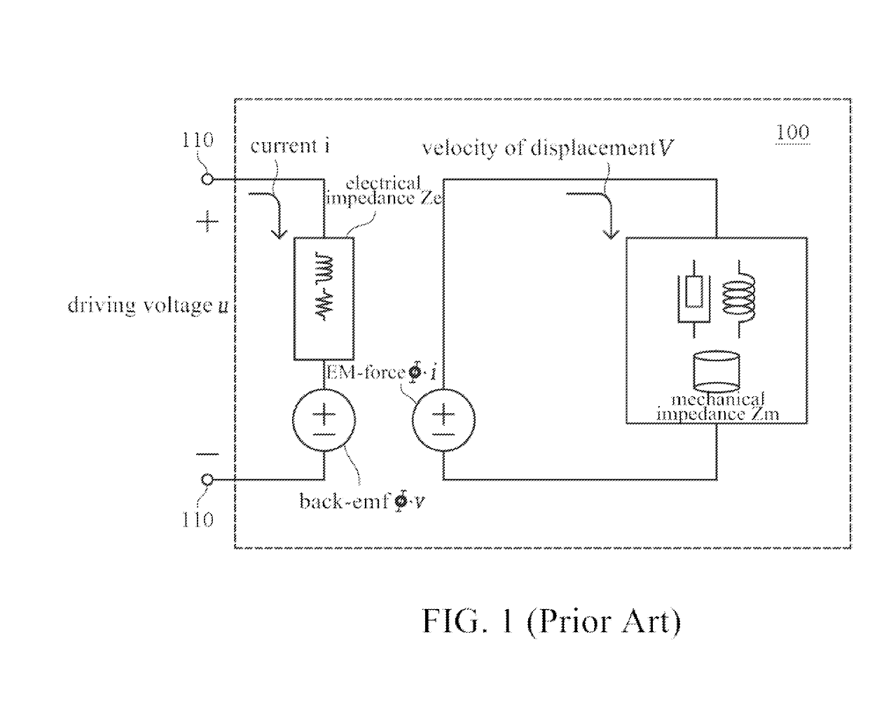

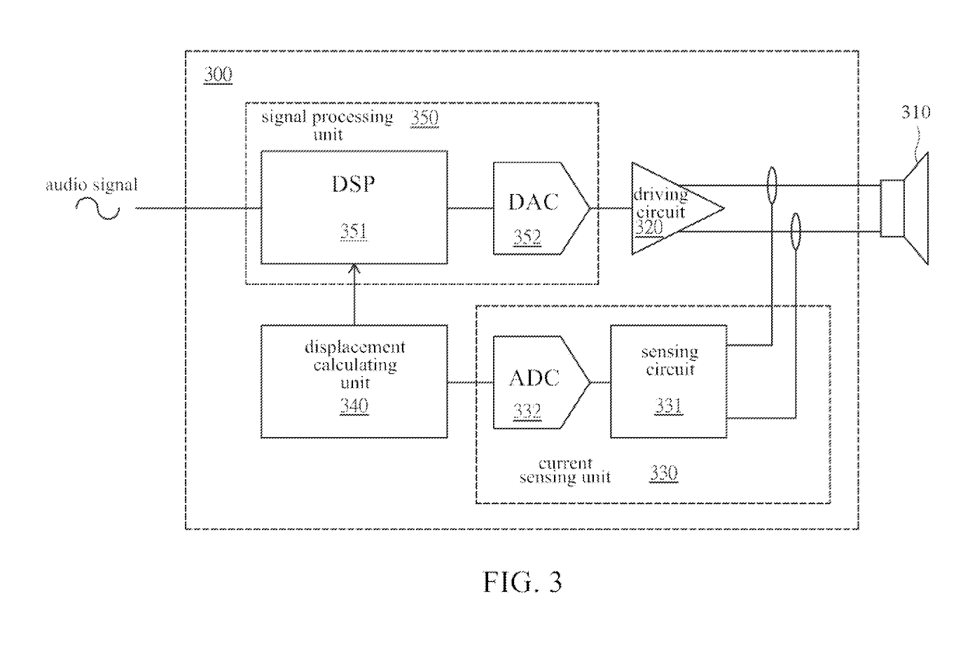

FIG. 3 is a circuit block diagram showing a device 300 for generating a driving signal of a loudspeaker 310 of the first embodiment of the present invention. The equivalent circuit of the loudspeaker 310 can be referred to FIG. 1 and the corresponding descriptions. The device 300 includes a driving circuit 320, a current sensing unit 330, a displacement calculating unit 340 and a signal processing unit 350.

The driving circuit 340 is coupled to the loudspeaker 310 and receives a control signal from the signal processing unit 350 to generate a driving voltage driving the loudspeaker 310. The current sensing unit 330 is coupled to the loudspeaker 310 and measures a current flowing through the loudspeaker 310 to generate a current signal. The displacement calculating unit 340 is coupled to the current sensing unit 330. The displacement calculating unit 340 calculates to derive a back-emf value according to the driving voltage, the current signal and the electrical impedance of the loudspeaker 310 and integrates the back-emf value to derive an integrating value.

The signal processing unit 350 is coupled to the displacement calculating unit 340 and the driving circuit 320. The signal processing unit 350 receives an audio signal to generate the control signal, and manipulates the control signal according to the integrating value to perform protection on the loudspeaker 310. For example, the signal processing unit 350 manipulates the amplitude of the driving voltage linearly or non-linearly such that the displacement of the diaphragm of the loudspeaker 310 is not greater than a limiting value to prevent the loudspeaker 310 from characteristics changing, life-time shortage, or even physical breakdown on the structure.

In more detail, the linear control on the amplitude of the driving voltage can be performed by amplifying or attenuating the audio signal with a dedicated gain value. The non-linear control on the amplitude of the driving voltage can be performed by non-linearly manipulating the gain value, such as the gain value is high when the audio signal is small and the gain value is low when the audio signal is large, or an upper limit of the driving voltage is defined to directly clip the driving signal when it intends to be higher than the upper limit. Note that there are many other methods for linear or non-linear control on the amplitude of the driving voltage. People skilled in the art can adopt different control methods according to various applications, thus, it will not be described further hereinafter.

The operating principle of the device 300 is described further. The equivalent circuit of FIG. 1 shows that the magnitude of the back-emf value equals the force factor Φ multiplying the velocity of displacement v of the diaphragm, and the displacement of the diaphragm equals the integral of the velocity of displacement v. Therefore, the integral of the back-emf is positive-correlating to the displacement of the diaphragm of the loudspeaker 310. Assume the displacement of the diaphragm is x, equation (4) can be shown as followed:

Φ·x=∫Φ·v·dt (4)

Furthermore, the aspect of the electrical property of the loudspeaker in FIG. 1 shows that the magnitude of the back-emf value equals the driving voltage u minus the cross voltage on the electrical impedance Ze. Therefore, since the driving voltage u is known, if the electrical impedance Ze is also known, by measuring the magnitude of the current i, the magnitude of the back-emf value can be calculated according to equation (5) shown as followed:

Φ·x=∫Φ·v·dt=∫(u−Zₑ·i)·dt (5)

It is worth noting that equation (5), in which the driving voltage u, the current i and the electrical impedance Ze are adopted for the calculation of the back-emf value, is interpreted as an embodiment of the present invention. The description of equation (5) is not intended to limit the scope of the present invention. For example, the driving voltage u and the current i can be adjusted with a percentage factor according to real applications, such as for complying with the adjustments on parameters of the equivalent circuit of the loudspeaker. People skilled in the art can perform adjustments on the aforementioned equations according to the selection of the parts and the way how signals are derived. The corresponding ways of adjustments can be directly known by people skilled in the art after understanding the embodiments disclosed in the present invention, and will not be described further hereinafter.

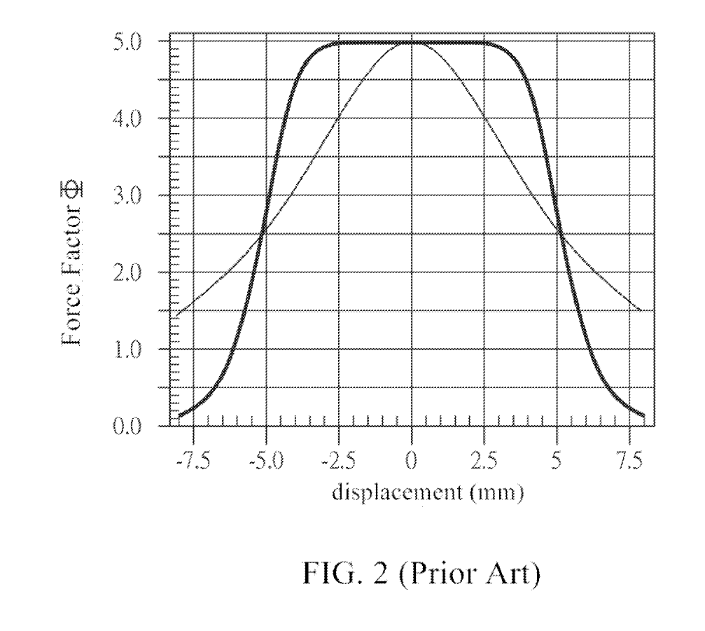

In more detail, the displacement x of the diaphragm can be derived by dividing the integrating value of the equation (5) by the force factor Φ. According to the category of the loudspeaker or the application scenario, the force factor Φ can be defined as either a constant or a function of the displacement x as shown in FIG. 2. The force factor Φ shown in FIG. 2 can be approximated as a function shown in equation (6) as followed:

Φ(x)=Φ(0)·(1−c₁·(x−c₂)²) (6),

wherein c₁ and c₂ are constants.

By substituting equation (6) into equation (5) and performing integration, a cubic equation of one unknown x can be derived. Consequently, the accurate solution of x can be further evaluated. Besides, since the operating range of the displacement x is already known, a look-up table, in which the integrating values derived from equation (5) and the corresponding displacements x are summarized, can be established in advanced and the displacement x can be evaluated according to the integrating value in equation (5). Compared to solving a cubic equation of one unknown, the derivation of the displacement x by the loop-up table can greatly save the algorithmic operation resources, and the chip area and power consumption can be further reduced.

It is worth noting that the electric impedance Ze of the loudspeaker can be defined according to the rating value written in the loudspeaker specification of the selected part. Nonetheless, in the embodiments of the present invention, since the current i can be measured by the device 300, the electric impedance Ze can be directly derived by measurement, such as driving the loudspeaker with a driving voltage u of a low frequency, by which the magnitude of the back-emf value can be neglected, and measuring the current i. Consequently, the electric impedance can be derived by dividing the driving voltage u by the current i.

Besides, as shown in FIG. 3, the signal processing unit 350 can further comprise a digital signal processor (DSP) 351 and a digital-to-analog converter (DAC) 352. The DSP 351 is coupled to the displacement calculating unit 340 and receives the audio signal. The DAC 352 is coupled to the DSP 351 and the driving circuit 320, and generates the control signal. The circuit topologies of the DSP 351 and the DAC 352 are well-known to people skilled in the art, and will not be described further hereinafter.

Moreover, as shown in FIG. 3, the current sensing unit 330 can further comprise a sensing circuit 331 and an analog-to-digital converter (ADC) 332. The sensing circuit 331 is coupled to the loudspeaker 310 to measure the current flowing through the loudspeaker 310. The ADC 332 is coupled to the sensing circuit 331 and the displacement calculating unit 340, and outputs the current signal. The circuit topologies of the sensing circuit 331 and the ADC 332 are well-known to people skilled in the art, and will not be described further hereinafter.

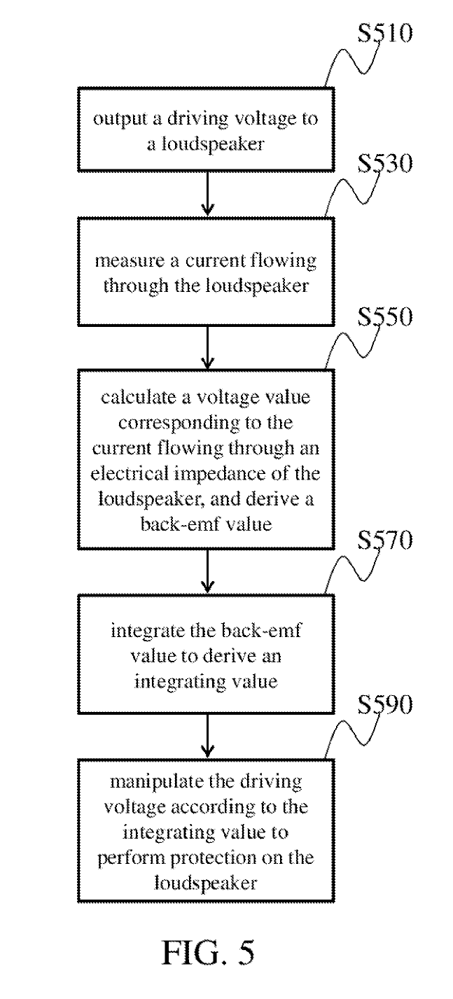

FIG. 5 is a flowchart of a method for generating a driving signal of a loudspeaker according to the second embodiment of the present invention. The method includes the following steps:

As shown in step S510, output a driving voltage to a loudspeaker.

As shown in step S530, measure a current flowing through the loudspeaker.

As shown in step S550, calculate to derive a voltage value corresponding to the current flowing through an electrical impedance of the loudspeaker, and calculate to derive a back-emf value by performing subtraction according to the driving voltage or a corresponding value thereof and the voltage value, such as by deriving a product by multiplying the current by the electrical impedance, and deriving the back-emf value by subtracting the product from the driving voltage.

As shown in step S570, integrate the back-emf value to derive an integrating value positive-correlating to a displacement of the diaphragm of the loudspeaker.

As shown in step S590, manipulate the driving voltage according to the integrating value to perform protection on the loudspeaker, wherein protection on the loudspeaker is performed by manipulating the amplitude of the driving voltage linearly or non-linearly such that the displacement of the diaphragm of the loudspeaker is not greater than a limiting value.

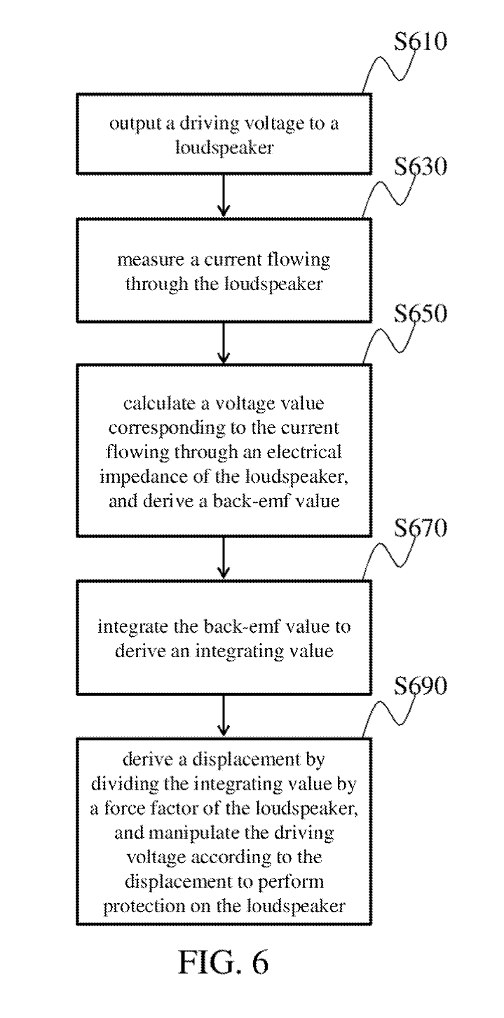

FIG. 6 is a flowchart of a method for generating a driving signal of a loudspeaker according to the third embodiment of the present invention. The method includes the following steps:

Steps S610, S630, S650 and S670 can be referred to related descriptions of steps S510, S530, S550 and S570 of the second embodiment of the present invention disclosed in FIG. 5.

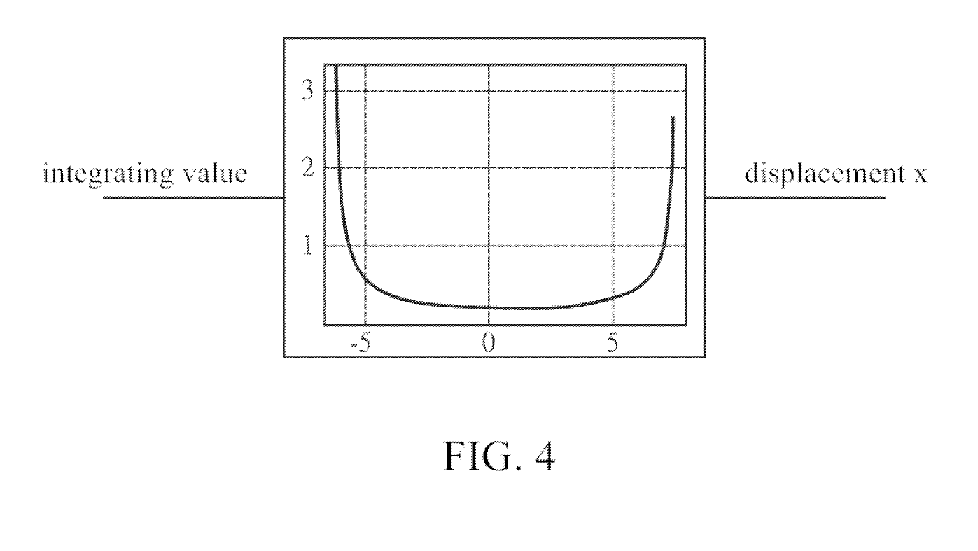

As shown in step S690, derive the displacement of the diaphragm by dividing the integrating value by a force factor of the loudspeaker, and manipulate the driving voltage according to the displacement to perform protection on the loudspeaker. Further, the force factor can be a function of the displacement. By substituting the function of the force factor versus the displacement into the integral function by which the integrating value is derived, the accurate solution of the displacement can be evaluated. On the other hand, a look-up table interpreting the function in FIG. 4 can be adopted to evaluate the displacement according to the integrating value. Besides, protection on the loudspeaker can be performed by manipulating the amplitude of the driving voltage linearly or non-linearly such that the displacement of the diaphragm of the loudspeaker is not greater than a limiting value.

The foregoing embodiments are illustrative of the characteristics of the present invention to enable a person skilled in the art to understand the disclosed subject matter and implement the present invention accordingly. The embodiments, however, are not intended to restrict the scope of the present invention. Hence, all equivalent modifications and variations made in the foregoing embodiments without departing from the spirit and principles of the present invention should fall within the scope of the appended claims.

What is claimed is:

1. A method for generating a driving signal of a loudspeaker, comprising the steps of:
outputting a driving voltage to said loudspeaker;
measuring a current flowing through said loudspeaker;
calculating to derive a voltage value corresponding to said current flowing through an electrical impedance of said loudspeaker, and calculating to derive a back-emf value by performing subtraction according to said driving voltage or a corresponding value thereof and said voltage value;
integrating said back-emf value to derive an integrating value positive-correlating to a displacement of the diaphragm of said loudspeaker; and
manipulating said driving voltage according to said integrating value to perform protection on said loudspeaker.

2. The method for generating a driving signal as of claim 1, wherein protection on said loudspeaker is performed by manipulating the amplitude of said driving voltage linearly or non-linearly such that said displacement of the diaphragm of said loudspeaker is not greater than a limiting value.

3. The method for generating a driving signal as of claim 1, wherein the step of calculating to derive said back-emf value further comprises deriving a product by multiplying said current by said electrical impedance, and deriving said back-emf value by subtracting said product from said driving voltage.

4. The method for generating a driving signal as of claim 3, wherein protection on said loudspeaker is performed by manipulating the amplitude of said driving voltage linearly or non-linearly such that said displacement of the diaphragm of said loudspeaker is not greater than a limiting value.

5. The method for generating a driving signal as of claim 1, further comprising the step of deriving said displacement by dividing said integrating value by a force factor of said loudspeaker, and manipulating said driving voltage according to said displacement to perform protection on said loudspeaker.

6. The method for generating a driving signal as of claim 5, wherein said force factor is a function of said displacement.

7. The method for generating a driving signal as of claim 6, wherein protection on said loudspeaker is performed by manipulating the amplitude of said driving voltage linearly or non-linearly such that said displacement of the diaphragm of said loudspeaker is not greater than a limiting value.

8. A device for generating a driving signal of a loudspeaker comprising:
a driving circuit, coupled to said loudspeaker, and receiving a control signal to generate a driving voltage;
a current sensing unit, coupled to said loudspeaker, and measuring a current flowing through said loudspeaker to generate a current signal;
a displacement calculating unit, coupled to said current sensing unit, calculating to derive a back-emf value according to said driving voltage, said current signal and the electrical impedance of said loudspeaker, and integrating said back-emf value to derive an integrating value; and
a signal processing unit, coupled to said displacement calculating unit and said driving circuit, receiving an audio signal to generate said control signal, and manipulating said control signal according to said integrating value to perform protection on said loudspeaker.

9. The device for generating a driving signal as of claim 8, wherein protection on said loudspeaker is performed by said signal processing unit manipulating the amplitude of said driving voltage linearly or non-linearly such that the displacement of the diaphragm of said loudspeaker is not greater than a limiting value.

10. The device for generating a driving signal as of claim 8, wherein said displacement calculating unit calculates to derive a voltage value corresponding to said current flowing through said electrical impedance of said loudspeaker, and derives said back-emf value by performing subtraction according to said driving voltage or a corresponding value thereof and said voltage value.

11. The device for generating a driving signal as of claim 10, wherein protection on said loudspeaker is performed by said signal processing unit manipulating the amplitude of said driving voltage linearly or non-linearly such that the displacement of the diaphragm of said loudspeaker is not greater than a limiting value.

12. The device for generating a driving signal as of claim 8, wherein said displacement calculating unit derives a product by multiplying said current signal by said electrical impedance, and derives said back-emf value by subtracting said product from said driving voltage.

13. The device for generating a driving signal as of claim 12, wherein protection on said loudspeaker is performed by said signal processing unit manipulating the amplitude of said driving voltage linearly or non-linearly such that the displacement of the diaphragm of said loudspeaker is not greater than a limiting value.

14. The device for generating a driving signal as of claim 8, wherein said signal processing unit comprises a digital signal processor (DSP) and a digital-to-analog converter (DAC), said DSP coupled to said displacement calculating unit and receiving said audio signal, said DAC coupled to said DSP and said driving circuit and generating said control signal.

15. The device for generating a driving signal as of claim 14, wherein protection on said loudspeaker is performed by said signal processing unit manipulating the amplitude of said driving voltage linearly or non-linearly such that the displacement of the diaphragm of said loudspeaker is not greater than a limiting value.

16. The device for generating a driving signal as of claim 8, wherein said current sensing unit comprises a sensing circuit and an analog-to-digital converter (ADC), said sensing circuit coupled to said loudspeaker to measure said current flowing through said loudspeaker, said ADC coupled to said sensing circuit and said displacement calculating unit and outputting said current signal.

17. The device for generating a driving signal as of claim 16, wherein protection on said loudspeaker is performed by said signal processing unit manipulating the amplitude of said driving voltage linearly or non-linearly such that the displacement of the diaphragm of said loudspeaker is not greater than a limiting value.

18. The device for generating a driving signal as of claim 8, wherein said displacement calculating unit further deriving a displacement of the diaphragm of said loudspeaker by dividing said integrating value by a force factor of said loudspeaker, and said signal processing unit manipulating said control signal according to said displacement to perform protection on said loudspeaker.

19. The device for generating a driving signal as of claim 18, wherein said force factor is a function of said displacement.

20. The device for generating a driving signal as of claim 19, wherein protection on said loudspeaker is performed by said signal processing unit manipulating the amplitude of said driving voltage linearly or non-linearly such that said displacement of the diaphragm of said loudspeaker is not greater than a limiting value.
